(19) United States
(12) Patent Application Publication
(10) Pub. No.: US 2022/0329084 A1
(43) Pub. Date: Oct. 13, 2022

(54) SELF-CHARGING SYSTEM FOR ELECTRIC VEHICLES

(71) Applicants: Vineet Tirth, Abha (SA); Anush Prabhakaran, Coimbatore (IN); Ram Karan Singh, Dehradun (IN); Puneet Kumar Gupta, Dehradun (IN); Santosh Kumar Singh, Delhi (IN); Rakesh Ranjan, Gurugram (IN); Rajesh Singh, Kolkata (IN)

(72) Inventors: Vineet Tirth, Abha (SA); Anush Prabhakaran, Coimbatore (IN); Ram Karan Singh, Dehradun (IN); Puneet Kumar Gupta, Dehradun (IN); Santosh Kumar Singh, Delhi (IN); Rakesh Ranjan, Gurugram (IN); Rajesh Singh, Kolkata (IN)

(21) Appl. No.: 17/809,333

(22) Filed: Jun. 28, 2022

(51) Int. Cl. H02J 7/00; H02J 9/06; B60L 50/15; B60L 53/22; B60L 58/18; B60L 58/12; B60L 58/25

(52) U.S. Cl. CPC H02J 7/0029; H02J 7/007; H02J 7/0013; H02J 7/0063; H02J 7/0048; H02J 9/061; B60L 50/15; B60L 53/22; B60L 58/18; B60L 58/12; B60L 58/25; H02J 2207/20; B60L 2210/30

(57) ABSTRACT

The present invention generally relates to a self-charging system for electric vehicles comprises at least one gearbox comprises an input end and an output end mechanically coupled to one of the wheels of a vehicle to the input end to generate a rotational energy with an increased output of one of the torque or speed (RPM) to the output end; an auxiliary generator connected to the output end of the at least one gearbox to convert the rotational energy into electrical energy; a controller equipped with a maximum power point tracker to produce maximum power output; and a charger controller coupled to the maximum power point tracker to charge a batter of the vehicle upon limiting electric current rate of the power output to protect against electrical overload, overcharging, and overvoltage.

### FIELD OF THE INVENTION

The present disclosure relates to battery charging systems, in more details, a self-charging system for electric vehicles battery charging.

### BACKGROUND OF THE INVENTION

Electrical Vehicles (EV) require a plug-in solution with a specialised high voltage and amperage alternating current (AC) outlet and pricey rectifiers to give the device with adequate conditioned DC electrical charge to full out the DC batteries. While many attempts at wireless charging are known in the art, all such innovations require a very small gap of no more than a few inches or touch between the transmitting and receiving coils to transfer power from the source to a device and do not address the issue of rapid transfer of vast amounts of energy or the automated configuration, security, authentication, and conditioning of the power to the specific device that requires charging.

Currently, several hours are required to charge the storage device to a high voltage of up to approximately DC 400V, for example, by connecting a power source plug, or in other words an outlet, of an AC 100V or AC 200V household commercial power source to the vehicle body, and because this amount of time is excessive, an electric vehicle suffers greatly in terms of user-friendliness when compared to a gasoline vehicle with a fuel tank that can be filled quickly. The user must, however, wait at the charging station until the car battery is fully charged.

In the view of the forgoing discussion, it is clearly portrayed that there is a need to have a self-charging system for electric vehicles in order to reduce wastage of time while charging the vehicle battery.

### SUMMARY OF THE INVENTION

The present disclosure seeks to provide an automated vehicle battery charging system to avoid wastage of time while charging the battery of the electric vehicle.

In an embodiment, a self-charging system for electric vehicles is disclosed. The system includes at least one gearbox comprises an input end and an output end mechanically coupled to one of the wheels of a vehicle to the input end to generate a rotational energy with an increased output of one of the torque or speed (RPM) to the output end. The system further includes an auxiliary generator connected to the output end of the at least one gearbox to convert the rotational energy into electrical energy. The system further includes a controller equipped with a maximum power point tracker to produce maximum power output. The system further includes a charger controller coupled to the maximum power point tracker to charge a batter of the vehicle upon limiting electric current rate of the power output to protect against electrical overload, overcharging, and overvoltage.

In another embodiment, gearboxes are optionally interconnected to the wheels of the vehicle and the two, three, and four auxiliary generators according to the required electrical energy to charge the battery.

In another embodiment, the connection between the auxiliary generator and at least one gearbox is established upon engaging a shaft of the auxiliary generator to the at least one gearbox.

In another embodiment, the shaft of the generator is connected to the output end of the gearbox and through the internal configuration of gears of a gearbox, provides a given output torque and speed determined by the gear ratio.

In another embodiment, the system comprises an AC-DC converter interconnected to the auxiliary generator and maximum power point tracker to covert AC power source to DC power source.

In another embodiment, the charge controller is optionally connected to a secondary battery to avoid overheating of the battery of the vehicle, wherein the secondary battery is a backup battery when a primary battery is in use to provide electrical energy to the vehicle.

In another embodiment, once the primary battery charge percentage gets below a threshold value the secondary battery is replaced with the primary battery and thereby primary battery acts as the secondary battery and start to charge automatically.

An object of the present disclosure is to automatically charge the electric vehicle battery while driving.

Another object of the present disclosure is to charge the vehicle battery using the rotational motion of the vehicle wheels.

Yet another object of the present invention is to deliver an expeditious and cost-effective self-charging system for electric vehicles.

To further clarify advantages and features of the present disclosure, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a self-charging system for electric vehicles in accordance with an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION:

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

It will be understood by those skilled in the art that the foregoing general description and the following detailed description are exemplary and explanatory of the invention and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . a” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this invention belongs. The system, methods, and examples provided herein are illustrative only and not intended to be limiting.

Embodiments of the present disclosure will be described below in detail with reference to the accompanying drawings.

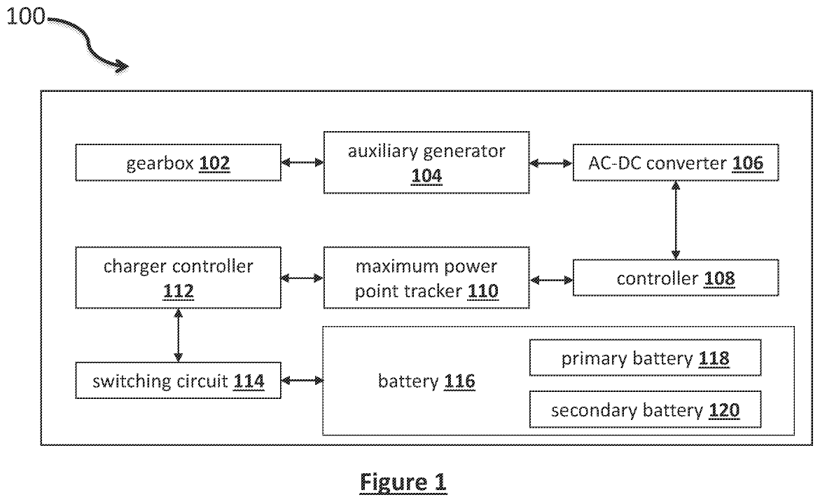

Referring to FIG. 1, a block diagram of a self-charging system for electric vehicles is illustrated in accordance with an embodiment of the present disclosure. The system 100 includes at least one gearbox 102 comprises an input end and an output end mechanically coupled to one of the wheels of a vehicle to the input end to generate a rotational energy with an increased output of one of the torque or speed (RPM) to the output end.

In an embodiment, an auxiliary generator 104 is connected to the output end of the at least one gearbox 102 to convert the rotational energy into electrical energy. The auxiliary generator 104 produces AC (alternating current) power source.

In an embodiment, an AC-DC converter 106 is interconnected to the auxiliary generator 104 and a maximum power point tracker 110 to covert AC power source to DC power source.

In an embodiment, a controller 108 is equipped with a maximum power point tracker 110 to produce maximum power output.

In an embodiment, a charger controller 112 is coupled to the maximum power point tracker 110 to charge a batter of the vehicle upon limiting electric current rate of the power output to protect against electrical overload, overcharging, and overvoltage.

In another embodiment, gearboxes 102 are optionally interconnected to the wheels of the vehicle and the two, three, and four auxiliary generators 104 according to the required electrical energy to charge the battery 116.

In another embodiment, the connection between the auxiliary generator 104 and at least one gearbox 102 is established upon engaging a shaft of the auxiliary generator 104 to the at least one gearbox 102.

In another embodiment, the shaft of the generator is connected to the output end of the gearbox 102 and through the internal configuration of gears of a gearbox 102, provides a given output torque and speed determined by the gear ratio.

In another embodiment, the charge controller 108 is optionally connected to a secondary battery 120 to avoid overheating of the battery of the vehicle, wherein the secondary battery 120 is a backup battery when a primary battery 118 is in use to provide electrical energy to the vehicle.

In another embodiment, once the primary battery 118 charge percentage gets below a threshold value the secondary battery 120 is replaced with the primary battery 118 and thereby primary battery 118 acts as the secondary battery 120 and start to charge automatically. The primary battery 118 to secondary battery 120 or secondary battery 120 to primary battery 118 is switched using a switching circuit 114.

In an alternate embodiment, a cooling system is attached with the battery 116 in case of single battery 116 (when only one battery is available in the vehicle) in order to avoid overheating of the vehicle battery.

In one embodiment, the gearbox 102 is a fully integrated mechanical arrangement consisting of a series of mating gears contained in a housing with shafts and bearings and in many cases a flange for wheel mounting. The gearbox 102 within a transmission can be one of several types, from bevel gears and spiral bevel gears to worm gears and others such as planetary gears. The gears are mounted on shafts that are carried by roller bearings and rotate about them.

The drawings and the forgoing description give examples of embodiments. Those skilled in the art will appreciate that one or more of the described elements may well be combined into a single functional element. Alternatively, certain elements may be split into multiple functional elements. Elements from one embodiment may be added to another embodiment. For example, orders of processes described herein may be changed and are not limited to the manner described herein. Moreover, the actions of any flow diagram need not be implemented in the order shown; nor do all of the acts necessarily need to be performed. Also, those acts that are not dependent on other acts may be performed in parallel with the other acts. The scope of embodiments is by no means limited by these specific examples. Numerous variations, whether explicitly given in the specification or not, such as differences in structure, dimension, and use of material, are possible. The scope of embodiments is at least as broad as given by the following claims.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component of any or all the claims.

1. A self-charging system for electric vehicles, the system comprises:
at least one gearbox comprises an input end and an output end mechanically coupled to one of the wheels of a vehicle to the input end to generate a rotational energy with an increased output of one of the torque or speed (RPM) to the output end;
an auxiliary generator connected to the output end of the at least one gearbox to convert the rotational energy into electrical energy;
a controller equipped with a maximum power point tracker to produce maximum power output; and
a charger controller coupled to the maximum power point tracker to charge a batter of the vehicle upon limiting electric current rate of the power output to protect against electrical overload, overcharging, and overvoltage.

2. The system of claim 1, wherein at least two gearboxes, at least three gearboxes, and at least four gearboxes are optionally interconnected to the wheels of the vehicle and the two, three, and four auxiliary generators according to the required electrical energy to charge the battery.

3. The system of claim 1, wherein the connection between the auxiliary generator and at least one gearbox is established upon engaging a shaft of the auxiliary generator to the at least one gearbox.

4. The system of claim 3, wherein the shaft of the generator is connected to the output end of the gearbox and through the internal configuration of gears of a gearbox, provides a given output torque and speed determined by the gear ratio.

5. The system of claim 1, wherein said system comprises an AC-DC converter interconnected to the auxiliary generator and maximum power point tracker to covert AC power source to DC power source.

6. The system of claim 1, wherein the charge controller is optionally connected to a secondary battery to avoid overheating of the battery of the vehicle, wherein the secondary battery is a backup battery when a primary battery is in use to provide electrical energy to the vehicle.

7. The system of claim 6, wherein once the primary battery charge percentage gets below a threshold value the secondary battery is replaced with the primary battery and thereby primary battery acts as the secondary battery and start to charge automatically.
